(19) United States
(12) Patent Application Publication
(10) Pub. No.: US 2025/0218310 A1
(43) Pub. Date: Jul. 3, 2025

(54) DIGESTIVE SYSTEM SIMULATOR APPARATUS AND PROCESS

(71) Applicant: NINTX PESQUISA E DESENVOLVIMENTO LTDA, São Paulo/SP/ (BR)

(72) Inventors: CRISTIANO RUCH WERNECK GUIMARÃES, São Paulo/SP/ (BR); MILLER NUNES DE FREITAS, São Paulo/SP/ (BR); KATIA SIVIERI, São Paulo/SP/ (BR)

(73) Assignee: NINTX PESQUISA E DESENVOLVIMENTO LTDA, São Paulo/SP/ (BR)

(21) Appl. No.: 18/397,649

(22) Filed: Dec. 27, 2023

(51) Int. Cl. G09B 23/30

(52) U.S. Cl. CPC G09B 23/303

(57) ABSTRACT

A digestive system simulator apparatus including at least one mobile rack and cabinets with 500 ml or 1500 ml reactors containing support for accessories, light indicator, bottles of acid and alkaline solution arranged in the front part of the support for accessories, a mechanism for coupling a hose to transfer acid or alkaline solution to the main peristaltic pump and, optionally, to the backup peristaltic pumps. The 500 ml or 1500 ml glass reactor contains means for magnetic and/or mechanical stirring, a mechanism for maintaining the temperature, a lid with multiple inlets, such as for pH sensor, temperature sensor, oxygen level sensor, pipette, inlet for backup connection or ammonia level sensor, allowing the connection of the hose for fluid transfer between reactors, being controlled by specific software operating on a computer, to control the entire apparatus automatically, as programmed by the user.

### FIELD OF THE DISCLOSURE

The present disclosure is in the field of biology, more specifically, in the field of in vitro devices simulating the digestive system.

### BACKGROUND OF THE DISCLOSURE

The development of new devices that simulate the digestive system allows an in-depth study of different gut microbiota, healthy or pathological, the evaluation of different treatments on the gut microbiota aiming at its modulation and, finally, its effects on the human body.

Digestion is a complex process of chemical and physical transformations carried out by the body with the intention of obtaining smaller, soluble and absorbable compounds from food. After digestion, the absorption of such compounds begins and, finally, after digestion and absorption, all elements that were not digested or absorbed are eliminated from the body.

In this way, the digestion process begins in the mouth, with chemical and physical processes carried out through chewing and the release of salivary enzymes, such as ptyalin or salivary amylase, for the preliminary degradation of macromolecules, in particular polysaccharides, such as starch. After this stage, the food is carried by peristaltic movements to the stomach. At this point, other specific enzymes, such as proteases, act to digest proteins. After passing through the stomach, the still undigested macromolecules reach the small intestine, where they are further degraded by pancreatic enzymes such as lipases (fat digestion), amylases (carbohydrate digestion) and again proteases (protein digestion), as well as bile secreted by the gallbladder to promote the absorption of small nutrients in the small intestine itself.

The intestine is composed in its initial portion of the small intestine, in which, as mentioned previously, a large part of the nutrients will be absorbed, taken to the bloodstream, and transported to all cells in the body. What is not absorbed by the small intestine (water, macromolecules that are not fully digested, hydrophilic molecules, which are not absorbable, insoluble fibers, etc.) will reach the large intestine, the majority of which is formed by the colon. It is in the colon, due to its anaerobic nature, where most of the gut microbiota resides, responsible for the main fermentation processes, allowing the digestion of complex carbohydrates and some proteins. It is also in the colon where water, mineral salts, and feces are formed.

The intestinal microbiota contains trillions of microorganisms, which corresponds to 100 times more genes than human genes. It is composed of several viruses, bacteria, fungi, and archaea that can have profound effects on controlling the proliferation of pathogenic bacteria present in the gastrointestinal tract, production and absorption of vitamins and nutrients, and regulation of the gastrointestinal, immune, endocrine and nervous systems. There are four main bacterial phyla that colonize the human gastrointestinal tract: Bacteiroidetes, Firmicutes, Proteobacteria and Actinobacteria.

Although it is already known that more than 99% of the species in the intestine are anaerobic, in-depth studies on the subject are still necessary, since not all species present are cultivable in conventional culture media.

Recent discoveries have demonstrated the great relevance and impact of the composition of the gut microbiota on the state of health and general well-being of humans, suggesting that there is a mutualistic and symbiotic relationship with the host. At the same time, it has been reported that a growing number of pathologies, such as those affecting the gastrointestinal, immune, endocrine, and nervous systems, have relevant contributions or even their origin from a state of dysbiosis (imbalance) of the gut microbiota.

Therefore, more in-depth studies are needed on how the physical-chemical processes of digestion in the human body and their changes can lead to dysbiosis, that is, how the imbalance of the gut microbiota affects a series of physiological processes, resulting in the emergence and/or worsening of intestinal and extra-intestinal pathological conditions. To this end, the physical-chemical variables of temperature and pH, the action of different enzymes on the digestion of macromolecules in the different compartments of the gastrointestinal tract, as well as the impact of different profiles of gut microbiota and corresponding metabolites on the human body must be considered. Also, one must analyze how different foods, ingredients, nutrients, microorganisms, biomolecules, organic molecules, natural products, metabolites, etc., collectively categorized as prebiotics, probiotics, postbiotics, or symbiotics, can modulate the composition and diversity of the gut microbiota and act on the prevention, mitigation, and even reversal of certain diseases.

Due to the difficulty and complexity of carrying out such studies in animal models or humans, over the years some in vitro simulation devices of the gastrointestinal system have been developed, some of which are described in the prior art.

For example, the technology called SHIME (Simulator of Human Intestinal Microbial Ecosystem) comprises a simulator of the gastrointestinal tract that contains 5 reactors connected in a fixed apparatus of large size to simulate the stomach, small intestine, and colon. Other technologies, such as SIMGI (Simulator of the Gastrointestinal Tract), focus only on the simulation of digestion in the stomach. PolyFermS immobilizes fecal material, the source of intestinal microbiota, in a central colonization reactor, the contents of which are distributed to other reactors. Another example of a gastrointestinal tract simulation apparatus is TIM-2, which has a vertical colon simulator that is capable of simulating small volumes and providing a more limited study on the effect of different active ingredients on the gut microbiota.

In vitro simulation models of the gastrointestinal system comprise reactors or compartments connected to each other, capable of being fed by different sources to allow their functioning, but, for the most part, they have a rigid, poorly adaptable structure. Additionally, most models require a stabilization period of at least 2 weeks for the inoculated intestinal microbiota in order for it to adapt to the in vitro conditions.

Currently, the prior art does not include satisfactory documents capable of solving the problems described above, which highlights the need for new solutions. Next, the main solutions revealed by the prior art will be presented, as well as their disadvantages and limitations.

Document WO 2010/118857 reveals an in vitro adhesion module that allows the growth, stabilization, and study of microbial communities that simulate host-microorganism interactions and adaptation. The module allows the supply of micromolar amounts of oxygen towards the adhered microorganisms, as well as the inclusion of cells to mimic the host.

Document WO 2019/203632 reveals a system that simulates the human digestive tract. In this system, physiological conditions of human digestion are simulated and the functioning of each reactor and physical-chemical parameters are controlled to emulate the human physiology.

Document CN 102533543 reveals a device simulating the human intestinal environment for culturing microorganisms in the intestinal tract, wherein said device consists of an upper box and a lower box. Furthermore, the device can maintain constant temperature and humidity or provide certain oscillation amplitudes and frequencies that can be adjusted to simulate the intestinal environment of the human body.

Document CN 108318625 reveals a model of bionic digestion for the human intestinal tract. Such system allows visualization of the human intestinal tract that contains a bionic stomach, small intestine, and large intestine. Furthermore, it simulates peristalsis using the peristaltic pump and water tank, controlled by the programmed logic controller and electromagnetic valves.

Although the disclosures described in the prior art documents present different formats and embodiments for the formation of devices simulating the human gastrointestinal tract, none of the devices described above are compact, flexible, and modular, thus allowing the combination of reactors in different embodiments, the elaboration of different experimental protocols with various durations of time, and the easy acquisition of biological and technical replicates according to the experimental need. Additionally, none of them is capable of combining the previously mentioned attributes with the ability to carry out more than one experiment simultaneously in parallel lines, allowing further expansion of biological and technical replicates.

Therefore, considering the prior art solutions, it is clear that none of them were able to solve the technical limitations that current simulation devices of the gastrointestinal tract in vitro possess. None of them anticipate the different aspects of the present disclosure either. In particular, none of the prior art documents describe or suggest an apparatus that presents compactability (compact model), mobility (mobile rack), modularity (plug & play reactor modules), parallelism (possibility of experiments on parallel lines) and, consequently, extreme flexibility, enabling the execution of various experimental protocols, and biological and technical replicates.

In this sense, the present disclosure proves to be an unprecedented and inventive option for the simulation of the gastrointestinal tract. It allows the efficient simulation of the digestion process from the stomach to the final part of the intestine, as well as the modulation of the gut microbiota, present in reactors that mimic the intestinal colon jointly or independently, and in different embodiments for the reactors, offering multiple protocols and experimental replicates. Taking all those points into account, the present disclosure offers a favorable solution to the previously presented technical limitations.

### OBJECTIVE OF THE DISCLOSURE

The present disclosure aims at providing a digestive system simulator apparatus that allows not only the performance of simulations in parallel embodiments and identical experimental conditions, but also arrangements in different embodiments and experimental conditions due to its extreme compactability, mobility, and modularity.

The present disclosure also aims at providing a digestive system simulator apparatus equipped with computerized control that allows precise analysis and monitoring.

### BRIEF DESCRIPTION OF THE DISCLOSURE

The present disclosure reveals a digestive system simulator apparatus comprising at least one mobile rack with at least two levels configured to support up to five cabinets each, and with at least one glass reactor on each level.

Each said cabinet comprises at least one support for accessories, said accessories comprising at least one bottle of acid solution and at least one bottle of alkaline solution. Furthermore, said support for accessories comprises at least one recess configured to allow the fitting of said bottles.

Each cabinet also includes at least one light indicator.

Additionally, each said cabinet comprises at least one glass reactor, said glass reactor containing a lid on its upper part.

Furthermore, each said cabinet comprises at least one peristaltic pump.

The mobile rack comprises on its upper part at least one backup peristaltic pump, on its lower part at least one heating bath with demand, at least one means of locomotion, and at least one distribution block for reactor heating.

Furthermore, each cabinet of the present apparatus is configured to simulate a portion of the human digestive tract.

Additionally, each cabinet is configured to operate the simulation of each portion of the gastrointestinal tract in parallel.

The lid of the bottles contains means of coupling configured to allow coupling of at least one hose to transfer acid solution and at least one hose to transfer alkaline solution.

Additionally, the alkaline solution in the bottle of alkaline solution is a sodium hydroxide (NaOH) solution.

Additionally, the acid solution in the bottle of acid solution is a hydrochloric acid (HCl) solution.

It is also noted that the peristaltic pumps of the cabinets with a 1500 mL reactor are configured to operate continuously.

Additionally, the peristaltic pumps of the cabinets with a 500 mL reactor are configured to operate semi-continuously.

Furthermore, the means of locomotion of the mobile rack of the present disclosure is selected from: wheels, rigid ball bearings, and transfer balls.

Moreover, the glass reactors of the present disclosure comprise a nutritional medium maintained in anaerobiosis through the daily injection of nitrogen.

The addition of acid and alkaline solutions to the glass reactor of each cabinet is carried out automatically.

Further, the daily injection of nitrogen into the glass reactor occurs for a period of 60 minutes.

The mobile rack of the digestive system simulator apparatus revealed by the present disclosure is made of at least one of the following metallic materials: iron, steel, carbon steel, stainless steel, aluminum, nickel, and titanium.

The glass reactors of the cabinets of the present disclosure are continuously stirred magnetically and/or mechanically in continuous fashion.

Furthermore, the lid of the glass reactor comprises a plurality of inlets, said plurality of inlets being configured to allow the coupling of at least one pH sensor; at least one temperature sensor; at least one pressure sensor; at least one volume sensor; at least one oxygen level sensor; at least one pipette; at least one ammonia level sensor; and at least one hose for fluid transfer.

### BRIEF DESCRIPTION OF FIGURES

The present disclosure is described in more detail based on the respective figures:

FIG. 1 reveals the front view of a cabinet 7 with 500 ml glass reactor 10 of the digestive system simulator apparatus 100 containing peristaltic pump 9, light indicator 13, lid 1, support for accessories 8, bottle of acid solution 11, bottle of alkaline solution 12.

FIG. 2 reveals the upper left side view of a cabinet 7 with 500 ml glass reactor 10 of the digestive system simulator apparatus 100 containing peristaltic pump 9, light indicator 13, lid 1, support for accessories 8, bottle of acid solution 11, bottle of alkaline solution 12.

FIG. 3 reveals the front view of two cabinets with glass reactors, one cabinet 7 with 500 ml glass reactor and another cabinet 14 with 1500 ml glass reactor, couplings of peristaltic pumps 9 to hoses for transportation of acid 19 and alkaline solution 20, and hose to transfer fluid 21 between the reactors.

FIG. 4 reveals the upper right-side view of two cabinets with glass reactors, a cabinet 7 with a 500 ml glass reactor, and a cabinet 14 with a 1500 ml glass reactor, couplings of peristaltic pumps 9 to hoses for transportation of acid solution 19 and alkaline 20, and hose to transfer fluid 21 between the reactors.

FIG. 5 reveals the front view of the digestive system simulator apparatus 100 on a mobile rack 18 and its additional elements: cabinet 7 with 500 ml glass reactor, cabinet 14 with 1500 ml glass reactor, backup peristaltic pumps 15, heating bath with demand 16 and distribution block for reactor heating 17.

FIG. 6 reveals the upper right-side view of the digestive system simulator apparatus 100 on a mobile rack 18 and its additional elements: cabinet 7 with 500 ml glass reactor, cabinet 14 with 1500 ml glass reactor, backup peristaltic pumps 15, heating bath with demand 16 and distribution block for reactor heating 17.

FIG. 7 reveals the top view of the lid 1 of the glass reactors 10 with a plurality of inlets, including at least one inlet for coupling of: at least one pipette 2, at least one ammonia level sensor 3, at least one pH sensor 4, at least one temperature sensor 5, and at least one oxygen level sensor 6.

FIG. 8 reveals the upper right-side view of the lid 1 of the reactors with a plurality of inlets, with at least one inlet for coupling of: at least one pipette 2, at least one ammonia level sensor 3, at least one pH sensor 4, at least one temperature sensor 5, and at least one oxygen level sensor 6.

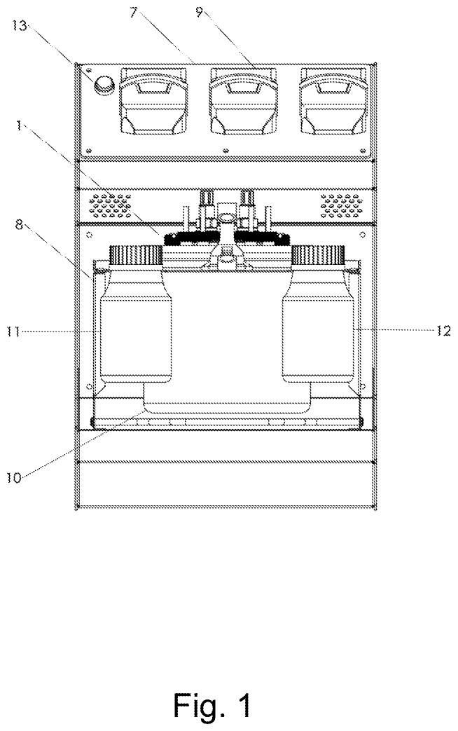

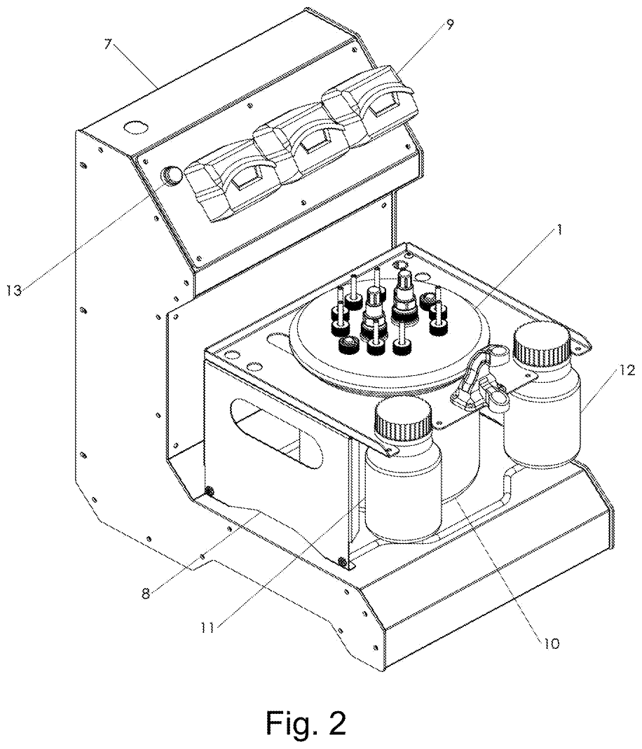

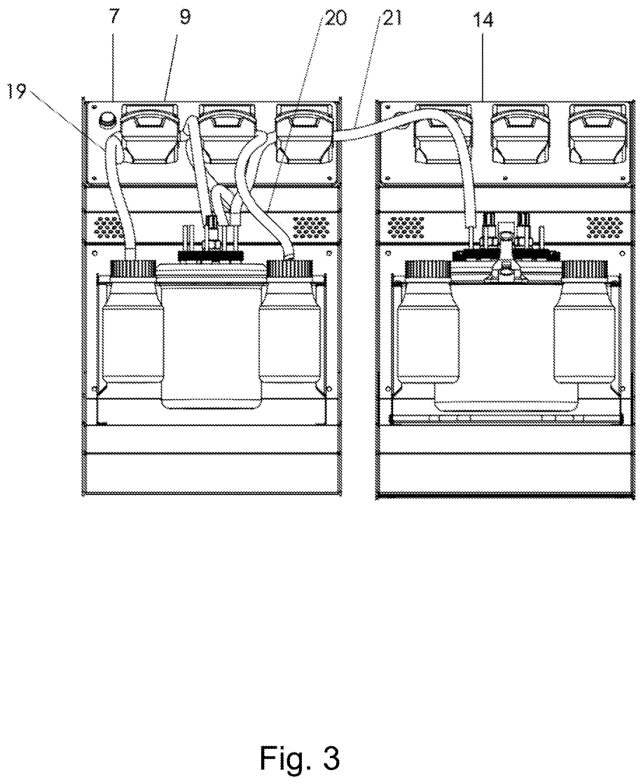

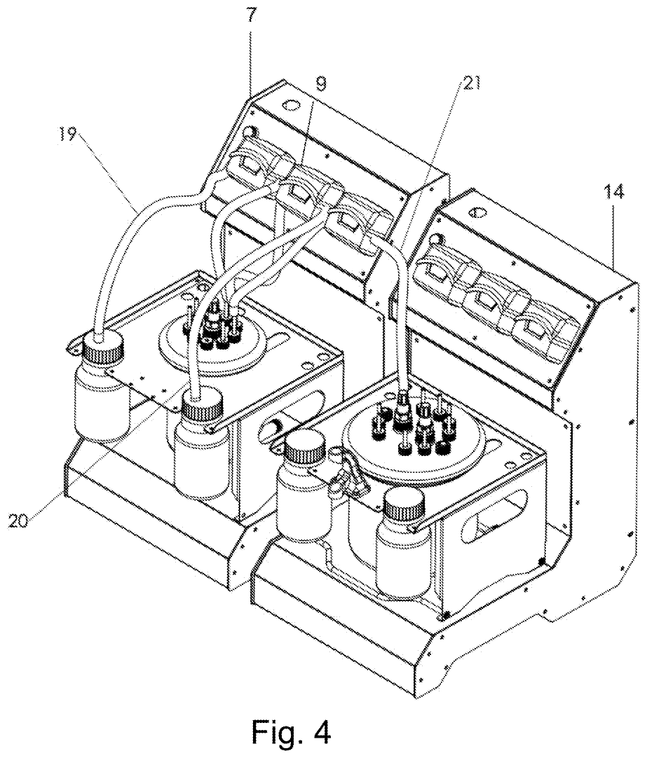

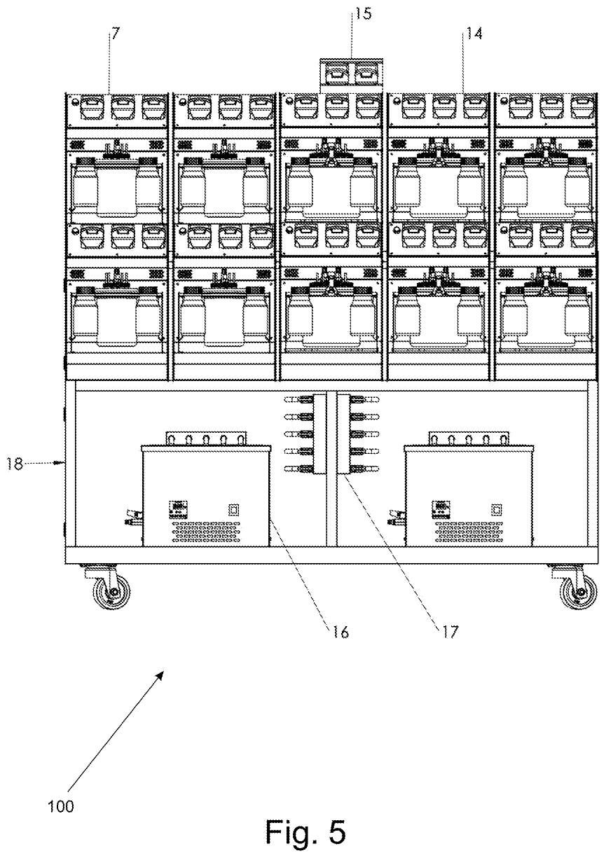

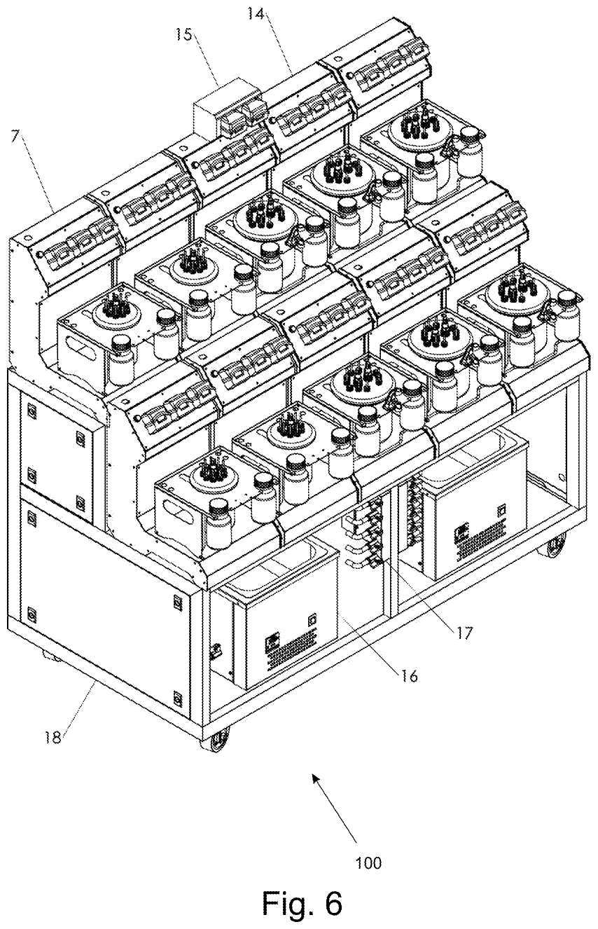

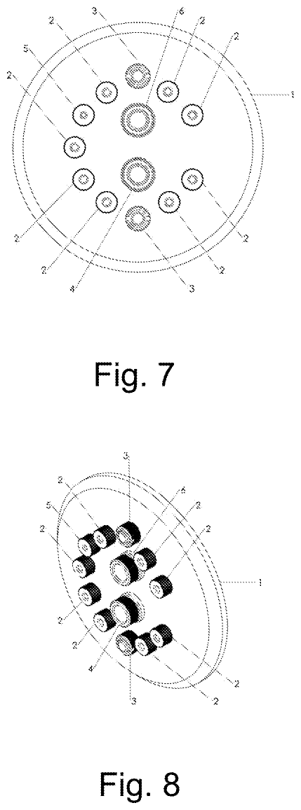

### DETAILED DESCRIPTION OF THE DISCLOSURE

Before the present disclosure is described in greater detail, it should be understood that this disclosure is not limited to the specific component parts of the digestive system simulator apparatus 100 described, as such components may vary. It should also be understood that the terminology used herein is solely for purposes of describing particular embodiments and is not intended to be limiting. It should be noted that, as used in this specification and in the appended claims, the forms “a”, “an” include their singular and/or plural denotations, unless the context indicates clearly the opposite. Furthermore, it should be understood that in case parameter ranges delimited by numerical values are provided, such ranges are considered to include these limiting values.

Furthermore, it must be understood that the modalities now should not be understood as individual modalities that would not be related to each other. Features discussed in one embodiment must also be in connection with other embodiments demonstrated herein. If, in a case, a specific feature is not with one embodiment, but with another, the person skilled in the art would understand that this does not necessarily mean that the feature is not intended to be disclosed in another embodiment. The person skilled in the art would understand that the essence of this request is to disclose the characteristic also for the other embodiment, but that for the purposes of clarity and to keep the present specification within a manageable content, this has not been done.

The present disclosure reveals a digestive system simulator apparatus 100, which has reactors that can be assembled in different embodiments in a modular way. Furthermore, said digestive system simulator apparatus 100 allows parallel experiments to be carried out. This modularity feature is of great value in the experimental field regarding the simulation of the gastrointestinal tract, since the flexibility of embodiments allows experiments to be carried out according to different experimental protocols defined by the user. For example, short-term protocols aimed at selecting active prebiotics, probiotics, postbiotics, or symbiotics, and also long-term protocols aimed at deeper studies of modulating the intestinal microbiota, obtaining specific profiles for it, production of metabolites with potential for therapeutic action, etc. The great modularity and parallelism of the disclosure, therefore, allow biological and technical replicates to be obtained quickly.

Another example of the advantage of parallelism is allowing the balance of a certain gut microbiota to occur in one of the lines of the apparatus, using, for example, different nutritional media, while in another line an independent experiment is carried out to investigate an active prebiotic, probiotic, postbiotic, or symbiotic. The parallel embodiment therefore accelerates the stabilization process of the inoculated gut microbiota to less than 2 weeks.

Several factors can affect the gut microbiota simulated in the digestive system simulator apparatus 100. Physicochemical parameters such as residence time, volume, flow, temperature, pH and oxygen level, nutritional media and digestive enzymes, in addition to the active ingredients themselves, i.e., prebiotics probiotics, postbiotics or symbiotics, are examples of parameters that can alter the simulated gut microbiota.

Thus, the present disclosure provides an apparatus that allows the simulation of the gastrointestinal tract under different conditions, with monitoring, analysis, and precise control of physicochemical parameters automatically through a specific software. The present disclosure also allows the investigation and optimization of different nutritional media and digestive enzymes, as well as the evaluation of the potential of different prebiotics, probiotics, postbiotics, or symbiotics to modulate the gut microbiota.

The sampling of aliquots from the reactors throughout the simulation allows metagenomics studies to evaluate the change in the profile of microorganisms in the gut microbiota and inferences about the increase in their diversity and reversal of dysbiosis states, and metabolomics studies to investigate metabolites produced with therapeutic potential and/or that can regulate physiological functions of the human organism.

To overcome the simulators described in the prior art, the present disclosure reveals an in vitro simulator apparatus with up to five reactors in each line (level) to mimic the different compartments of the gastrointestinal tract: stomach, small intestine, ascending colon, transverse colon, and descending colon.

Within the scope of the present disclosure, the term “reactor” refers to the set consisting of a glass reactor 10, support for accessories 8, and bottles of acid 11 and alkaline solution 12.

The digestive system simulator apparatus 100 revealed by the present disclosure comprises at least one mobile rack 18, with at least two levels to support up to five cabinets with reactors on each level, said levels being located in the middle and upper portions of the mobile rack 18. Each cabinet is independent and modular and comprises at least one support for accessories 8, at least one light indicator 13, at least one glass reactor 10, and at least one peristaltic pump 9.

Furthermore, each cabinet simulates a portion of the human digestive tract. Among the five cabinets with reactors located on each level, at least one cabinet simulates the stomach; at least one cabinet simulates the small intestine; at least one cabinet simulates the ascending colon; at least one cabinet simulates the transverse colon; and at least one cabinet simulates the descending colon, allowing the complete simulation of the gastrointestinal tract in parallel under identical or different physicochemical and biological conditions.

In some embodiments of the present disclosure, said support for accessories 8 has at least one recess for fitting a bottle of acid solution 11 or a bottle of alkaline solution 12 in its front part. In an alternative embodiment of the present disclosure, one bottle of acid solution 11 and one bottle of alkaline solution 12 or two bottles of acid solution 11 or two bottles of alkaline solution 12 can be fitted to the recesses of the support for accessories 8.

In some embodiments of the present disclosure, each bottle 11,12 contains, on its upper part, couplings to a hose for transportation of acid solution 19 and to a hose for transportation alkaline solution 20.

In some embodiments of the present disclosure, the couplings to a hose ro transfer acid solution 19 and to a hose to transfer alkaline solution 20 on the upper part of each bottle 11,12 are selected from: hydraulic connections of tubular type, forged, tupy, and bsp threads.

In some embodiments of the present disclosure, the hoses 19,20 are directed from the upper part of each bottle 11,12 to the main peristaltic pump 9. In some embodiments of the present disclosure, the hoses 19,20 are directed from the upper part of each bottle 11,12 up to the backup peristaltic pumps 15.

In some embodiments of the present disclosure, at least one glass reactor 10 has a volume of 500 mL and is part of cabinet 7.

In some embodiments of the present disclosure, at least one glass reactor 10 has a volume of 1500 mL and is part of cabinet 14.

In some embodiments of the present disclosure, the glass reactor 10 is a double-coated glass reactor.

In some embodiments of the present disclosure, the glass reactors 10 are magnetically stirred in a continuous fashion to mimic the peristaltic movement.

In some embodiments of the present disclosure, the glass reactors 10 are mechanically agitated in a continuous fashion to mimic the peristaltic movement.

Additionally, the plurality of glass reactors 10 is maintained at a constant temperature by means of a thermostat integrated into the cabinets 7, 14. In some embodiments of the present disclosure, the temperature of at least one of the many glass reactors 10 is between 30 and 40° C., preferably between 35 and 38° C., more preferably at 37° C.

The cabinets 7,14 of the present disclosure comprise means for entering the acid solution and the alkaline solution, allowing the modulation of the pH of the gut microbiota solution inside the glass reactor 10.

In some embodiments of the present disclosure, the glass reactor 10 has on its upper part a lid 1 with a plurality of inlets. In some embodiments of the present disclosure, said plurality of inlets located in the lid 1 of the glass reactor 10 is configured to, but not limited, couple at least one pH sensor 4, at least one temperature sensor 5, at least one oxygen level sensor 6, at least one pipette 2, at least one inlet for backup connection or ammonia level sensor 3, and to allow connection of the hose to transfer fluid 21 between the plurality of glass reactors 10.

In the simulation of the digestive process of the human organism carried out by the present disclosure, the peristaltic pumps 9,15 promote the entry of acid and alkaline solutions into each glass reactor 10 and the transfer of fluids between the cabinets 7 with 500 mL reactors, between the cabinets 14 with 1500 mL reactors and between cabinets 7 and 14. For a reliable reproduction of the human digestive process, the pumps of the cabinets can operate in different ways, precisely simulating the semi-continuous process of duodenal-gastric filling and emptying after digestion in these compartments. In the large intestine, the flow is continuous and without complete emptying of the compartments.

In some embodiments of the present disclosure, in a complete simulation of the human gastrointestinal tract involving all five cabinets with reactors on at least one level, the peristaltic pumps 9 of cabinets with the 500 mL reactor that simulate the stomach and small intestine and the backup peristaltic pumps 15, if necessary, operate semi-continuously.

In some embodiments of the present disclosure, in a complete simulation of the human gastrointestinal tract involving all five cabinets with reactors on at least one level, the peristaltic pumps 9 of the cabinets with the 1500 mL reactor that simulate the 3 portions of the colon and the backup peristaltic pumps 15, if necessary, operate continuously.

In some embodiments of the present disclosure, in a simulation with biological replicates of the ascending colon, the transverse colon, or the descending colon, the peristaltic pumps 9 and the backup peristaltic pumps 15 transfer fluids in parallel from cabinet 7 with the 500 mL reactor that simulates the small intestine to three cabinets 14 with 1500 mL reactor that simulate portions of the colon.

In some embodiments of the present disclosure, the material of the mobile rack 18 is at least one of the following metallic materials: iron, steel, carbon steel, stainless steel, aluminum, nickel, and titanium.

In some embodiments of the present disclosure, the mobile rack 18 has, in its lower part, at least one distribution block for reactor heating 17.

In some embodiments of the present disclosure, the mobile rack 18 has, in its lower part, at least one heating bath with demand 16.

In some embodiments of the present disclosure, the cabinets with reactors 7,14 and their interactions with the system and its other parts are controlled by software operating on a computer allowing control of the entire digestive system simulator apparatus 100 automatically, as programmed by the user.

In some embodiments of the present disclosure, the mobile rack 18 has, in its lower part, means of locomotion to allow movement of the digestive system simulator apparatus 100.

In some embodiments of the present disclosure, such means of locomotion are selected from: wheels, rigid ball bearings, and transfer balls.

In some embodiments of the present disclosure, the nutritional medium is maintained in anaerobiosis by the daily injection of nitrogen, preferably, for a time between 1 minute to 2 hours, more preferably, for a time between 30 to 90 minutes, even more preferably, for a time of 60 minutes.

The appropriate pH of each compartment of the gastrointestinal tract is controlled by the addition of a strong base and/or a strong acid, where such addition is automatic and carried out using specific software operating on a computer.

In some embodiments of the present disclosure, the strong base used is NaOH and the strong acid used is HCl.

In the case of simulations that include the small intestine, the reactor that simulates that portion of the gastrointestinal tract operates under neutral conditions. In the case of simulations comprising the three portions of the colon, different pHs are used.

In some embodiments of the present disclosure, the pH of the ascending portion of the colon is between 5.6 and 5.9; the pH of the transverse portion of the colon is between 6.1 and 6.4; the pH of the descending portion of the colon is between 6.6 and 6.9.

In some embodiments of the present disclosure, the apparatus comprises ten cabinets with at least one glass reactor 10 each, with five cabinets with glass reactors 10 arranged in a line, side by side, at each level, where each cabinet with glass reactor 10 corresponds to a compartment of the gastrointestinal tract (stomach, small intestine, ascending, transverse and descending colon), allowing two complete simulations of the digestive system in parallel under physicochemical and biological conditions that are identical or different from each other.

Each glass reactor 10 comprises a lid 1 with multiple inlets, which allow the (i) connection of sensors of different types, such as pH, temperature, flow, oxygen level, ammonia level, as well as (ii) the inlet of pipettes for sample collection and injection of solutions, reagents, and active ingredients, (iii) auxiliary connections and sensors and (iv) the attachment of devices that can increase the complexity of the system, simulating intestinal mucus, for example. The lid 1, therefore, allows control of different aspects of the gastrointestinal tract simulation, according to the user's needs.

### EXAMPLES

The examples presented below only show some of the countless ways to implement the present disclosure without limiting its scope.

In an example of the present disclosure, the apparatus 100 comprises two parallel lines, each with five cabinets with 500 ml 7 or 1500 ml 14 reactors on two levels. Each line independently simulates the different compartments of the human gastrointestinal tract, with their respective pH values, temperature, oxygen level, digestive enzymes, residence time, flow, and volumetric capacity. The reactors contain double-coated glass reactors 10, which are connected by means of peristaltic pumps 9. In the case of a complete simulation of the gastrointestinal tract using the five reactors in each line, the first two reactors, corresponding to the stomach and small intestine, follow a principle of filling and emptying, adding two to three times a day a specific nutritional medium and pepsin to simulate the gastric compartment, and pancreatic juice and bile to simulate the small intestine compartment. After digestion in the gastric and duodenal compartments, the contents of the second reactor are transferred to the third reactor, which simulates the ascending portion of the colon, followed by the fourth (transverse portion) and fifth (descending portion) reactors, without emptying the last three reactors-there is addition of fermentation medium, keeping the volume constant. The intestinal microbiota under study is inoculated only in reactors that simulate the colon and such reactors are maintained in anaerobic conditions (absence of oxygen).

Fluid retention times in reactors that simulate the upper gastrointestinal tract can be modulated by altering flow rates between the gastric and small intestine compartments to simulate their filling and emptying. Meanwhile, the fluid retention times in the reactors that simulate the three portions of the colon are modulated mainly to maintain a constant volume in these compartments. Preferably, a total retention time of 24 hours to 76 hours is used in the last three reactor cabinets in order to accurately simulate the digestion time in the colon.

In some embodiments of the present disclosure, the apparatus 100 comprises nine cabinets with reactors, five cabinets in the upper line of the mobile rack 18 and four cabinets in the lower line.

In some embodiments of the present disclosure, the apparatus 100 comprises eight cabinets with reactors, with five or four cabinets in the upper line, and three or four cabinets in the lower line.

In some embodiments of the present disclosure, the apparatus 100 comprises seven cabinets with reactors, with five or four cabinets in the upper line and two or three cabinets, respectively, in the lower line.

In some embodiments of the present disclosure, the apparatus 100 comprises six cabinets with reactors, with five, four or three cabinets in the upper line and one, two or three cabinets, respectively, in the lower line.

In some embodiments of the present disclosure, the apparatus 100 comprises five cabinets with reactors, with four or three cabinets in the upper line and one or two cabinets, respectively, in the lower line.

In some embodiments of the present disclosure, the apparatus 100 comprises four cabinets with reactors, with three or two cabinets in the upper line and one or two cabinets, respectively, in the lower line.

In some embodiments of the present disclosure, the apparatus 100 comprises three cabinets with reactors, two cabinets in the upper line and one cabinet in the lower line.

In some embodiments of the present disclosure, the apparatus 100 comprises two cabinets with reactors, one cabinet in the upper line and one cabinet in the lower line. For cases in which the number of cabinets with reactors arranged in the mobile rack 18 is odd, there is also the possibility that the number of cabinets in the lower line will be greater than the number of cabinets in the upper line, in any possible combination. With this versatility of embodiments, it is additionally possible, for example, to simulate the gastrointestinal tract of patients who have undergone surgical removal of some portion of the digestive system, such as bariatric and oncology patients, opening up possibilities for developing therapeutic interventions that can benefit physiological complications in such patients.

Examples of pH, retention times, reactor volumes, and preferred fluid volumes can be seen in Table 1, reproduced below.

TABLE 1
Reactor and fluid volumes, retention times and pH in each
reactor of the digestive system simulator apparatus 100.

| | Reactor | Fluid | Retention | |
|---|---|---|---|---|
| | volume | volume | time | |
| Reactor | (mL) | (mL) | (h) | pH |
| R1 | 500 | 200 | 2.5 | 2.0 |
| R2 | 500 | 200 | 4 | — |
| R3 | 1500 | 500 | 20 | 5.6-5.9 |
| R4 | 1500 | 800 | 32 | 6.1-6.4 |
| R5 | 1500 | 600 | 24 | 6.6-6.9 |

R1: Stomach;
R2: Small intestine;
R3: Ascending colon;
R4: Transverse colon;
R5: Descending colon

Thus, the digestive system simulator apparatus 100 permits the use, in a modular manner, of one to five cabinets with reactors 7, 14 in each of the two lines, allowing parallelism of the experiments, from one to ten compartments of the gastrointestinal tract to be simulated at once, chosen from the stomach, small intestine, ascending colon, transverse colon and descending colon.

1. A digestive system simulator apparatus, comprising at least one mobile rack with at least two levels configured to support up to five cabinets each, with at least one glass reactor on each level, each cabinet comprising:
at least one support for accessories, wherein said accessories comprise at least one bottle of acid solution and at least one bottle of alkaline solution, and wherein said support for accessories further comprises at least one recess configured to allow the fitting of said bottles;
at least one light indicator;
at least one glass reactor, said glass reactor containing a lid on its upper part;
at least one peristaltic pump; and
wherein said mobile rack comprises in its upper part at least one backup peristaltic pump and in its lower part at least one heating bath with demand, at least one means of locomotion and at least one distribution block for reactor heating.

2. The digestive system simulator apparatus of claim 1, wherein each cabinet of the apparatus is configured to simulate a portion of the human digestive tract.

3. The digestive system simulator apparatus of claim 2, wherein each cabinet is configured to operate a simulation of each portion of the gastrointestinal tract in parallel.

4. The digestive system simulator apparatus of claim 1, wherein the lid of the bottles contains means of coupling configured to allow coupling of at least one hose to transfer acid solution and at least one hose for transportation of alkaline solution.

5. The digestive system simulator apparatus of claim 1, wherein the alkaline solution in the bottle of alkaline solution is a sodium hydroxide (NaOH) solution.

6. The digestive system simulator apparatus of claim 1, wherein the acid solution in the bottle of acid solution is a hydrochloric acid (HCl) solution.

7. The digestive system simulator apparatus of claim 2, wherein peristaltic pumps of cabinets with a 1500 mL reactor are configured to operate continuously.

8. The digestive system simulator apparatus of claim 2, wherein peristaltic pumps of cabinets with a 500 mL reactor are configured to operate semi-continuously.

9. The digestive system simulator apparatus of claim 1, wherein the means of locomotion of the mobile rack are selected from: wheels, rigid ball bearings, and transfer balls.

10. The digestive system simulator apparatus of claim 1, wherein the glass reactors comprise a nutritional medium maintained in anaerobiosis by a daily injection of nitrogen.

11. The digestive system simulator apparatus of claims 5, wherein the acid and alkaline solutions are added automatically to the glass reactor of each cabinet.

12. The digestive system simulator apparatus of claim 10, wherein the daily injection of nitrogen into each glass reactor occurs for 1 minute to 2 hours.

13. The digestive system simulator apparatus of claim 1, wherein the mobile rack is made of at least one of the following metallic materials: iron, steel, carbon steel, stainless steel, aluminum, nickel, and titanium.

14. The digestive system simulator apparatus of claim 1, wherein each glass is stirred magnetically and/or mechanically in continuous fashion.

15. The digestive system simulator apparatus of claim 1, wherein the lid of each glass reactor comprises a plurality of inlets, said plurality of inlets being configured to allow the coupling of:
at least one pH sensor;
at least one temperature sensor;
at least one pressure sensor;
at least one volume sensor;
at least one oxygen level sensor;
at least one pipette;
at least one ammonia level sensor;
and at least one hose for fluid transfer.

16. A process for operating the digestive system simulator apparatus as defined in claim 1, comprising:
i) Cleaning of all reactors using:
hot water;
a solution of water and activated chlorine;
70% isopropyl alcohol;
distilled water;
ii) Cleaning all lids, hoses and connections using:
1. autoclave;
2. water and detergent;
3. 70% isopropyl alcohol;
4. distilled water;
iii) Assembling the digestive system simulator apparatus after i) and ii);
iv) Programming software for the digestive system simulator apparatus with all the parameters to automate the simulation;
v) Calibrating the pumps;
vi) Calibrating all pH sensors;
vii) Innoculating intestinal microbiota in reactors simulating colon portions;
viii) Feeding the apparatus with nutritional medium for 14 days;
ix) Feeding the apparatus with pepsin, pancreatic juice and nutritional medium for 7 days;
x) Feeding the apparatus with pepsin, pancreatic juice, nutritional medium and active ingredients, for up to 14 days;
xi) Maintaining of anaerobiosis using a nitrogen generator; and
xii) Removing of sample aliquots from the reactors.

17. The process of operating the digestive system simulator apparatus of claim 16, wherein x) comprises feeding prebiotics, probiotics, postbiotics, or symbiotics.
